(19) United States
(12) Patent Application Publication
(10) Pub. No.: US 2011/0185024 A1
(43) Pub. Date: Jul. 28, 2011

(54) EMBEDDABLE METADATA IN ELECTRONIC MAIL MESSAGES

(75) Inventors: Vishwanath Tumkur Ramarao, Sunnyvale, CA (US); Mark E. Risher, San Francisco, CA (US)

(73) Assignee: YAHOO! INC., Sunnyvale, CA (US)

(21) Appl. No.: 12/694,173

(22) Filed: Jan. 26, 2010

(51) Int. Cl. G06F 15/16

(52) U.S. Cl. 709/206

(57) ABSTRACT

Disclosed are apparatus and methods for annotating an electronic mail message and processing the annotated electronic mail message. More particularly, an electronic mail message may be generated and annotated such that the electronic mail message includes metadata identifying data provided in the electronic mail message. The electronic mail message may then be transmitted. When the annotated electronic mail message is received, at least a portion of the metadata may be obtained from the electronic mail message. At least a portion of the data in the electronic mail message may be identified using at least a portion of the metadata. At least a portion of the identified data in the electronic mail message may then be processed.

### BACKGROUND OF THE INVENTION

The present invention relates generally to computer implemented annotation of electronic mail messages with metadata and processing of annotated electronic mail messages.

Electronic mail messages are a common form of communication transmitted by individuals, businesses, and commercial institutions. Commercial companies send billions of electronic mail messages to Internet consumers every day. The intention of these commercial companies is often to prompt the user to visit their web site or take another action. Unfortunately, once the user reads the electronic mail message, the user may not visit the advertised web site or take the desired action.

### SUMMARY OF THE INVENTION

Apparatus and methods for generating and processing an electronic mail message including metadata are disclosed. More particularly an electronic mail message may be generated or modified to include metadata prior to transmitting the electronic mail message to the addressee(s) (i.e., recipient(s)) of the electronic mail message. When the recipient opens the electronic mail message, the electronic mail message may be processed.

In one embodiment, an electronic mail message is generated. The electronic mail message is annotated such that the electronic mail message includes metadata identifying data provided in the electronic mail message. For instance, the metadata may identify at least a portion of all data provided in the electronic mail message. The electronic mail message is then transmitted.

In accordance with another embodiment, an electronic mail message is received, where the electronic mail message includes metadata identifying data provided in the electronic mail message. For instance, the data that is identified by metadata may be at least a portion of all data provided in the electronic mail message. At least a portion of the metadata is obtained from the electronic mail message. At least a portion of data in the electronic mail message is identified using at least a portion of the metadata, enabling the identified data to be processed.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a block diagram illustrating an example system in which various embodiments may be implemented.

FIG. 2 is a process flow diagram illustrating an example method of annotating an electronic mail message.

FIG. 3 is a process flow diagram illustrating an example method of processing an annotated email.

FIGS. 4-6 are screen shots illustrating example annotated electronic mail messages that are presented in accordance with the corresponding metadata.

FIG. 7 is a simplified diagram of a network environment in which specific embodiments of the present invention may be implemented.

FIG. 8 illustrates an example computer system in which specific embodiments of the present invention may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

The disclosed embodiments enable an electronic mail message to be annotated with metadata in a structured manner. The electronic mail message may also be embedded with structured data. In this manner, a machine-readable component may be added to an electronic mail message, enabling rich, dynamic, and/or interactive content to be displayed in real-time.

Once annotated, the electronic mail message may be sent to the intended recipient(s). When the electronic mail message is opened by a recipient, data in the electronic mail message may be automatically processed in accordance with at least a portion of the metadata.

Annotating an electronic mail message may result in the association of metadata with at least a portion of data provided in the electronic mail message. For instance, metadata may be inserted into or attached to the electronic mail message in some manner. Various methods for annotating an electronic mail message will be described in further detail below.

The metadata may serve various purposes. The metadata may serve to identify at least a portion of the data (e.g., a data entity) in the electronic mail message. The metadata may also indicate one or more actions to be performed in association with the data. In accordance with various embodiments, the metadata that identifies a data entity may be referred to as a tag.

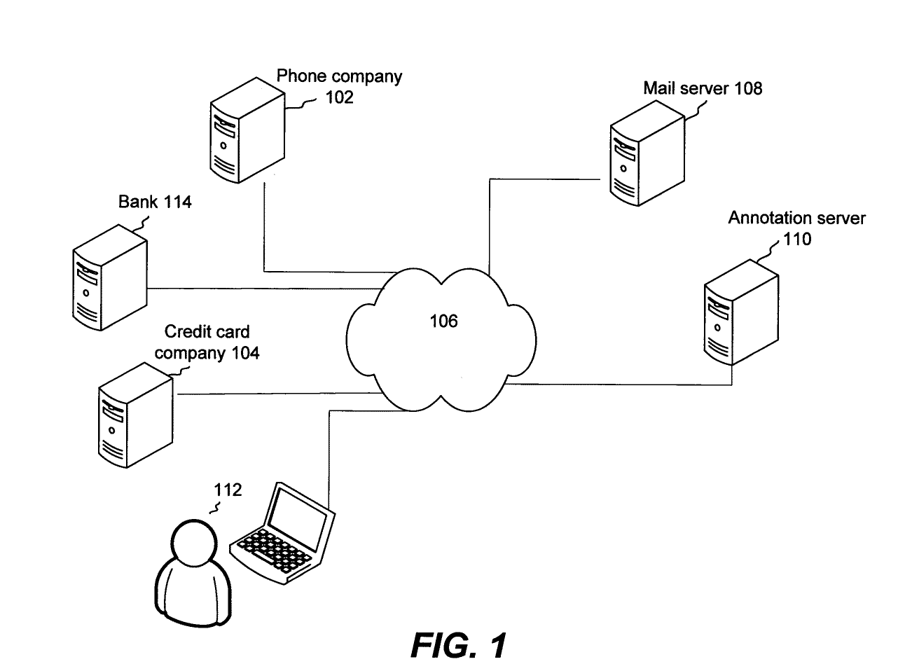

FIG. 1 is a block diagram illustrating an example system in which various embodiments supporting annotation of electronic mail messages and processing of electronic mail messages may be implemented. When a sender generates an electronic mail message for transmission to the electronic mail address of one or more recipient(s), the sender may provide data in the electronic mail message (e.g., a body of the electronic mail message) and annotate the electronic mail message. More particularly, the sender may compose and annotate the electronic mail message using an electronic mail messaging program and/or associated annotation program, which may be implemented via one or more servers or clients (not shown) maintained by or accessed by the sender. For example, the sender may be a company such as a phone company 102, a credit card company 104, or a bank. Once the annotated electronic mail message is transmitted over the Internet 106, a web site that hosts a recipient's electronic mail address may forward the electronic mail message to an electronic mail box associated with the electronic mail address.

A web site that hosts the electronic mail address may be supported by one or more servers. In this example, the web site includes a mail server 108 and an annotation server 110. However, it is important to note that the functions described herein may also be performed by a single server, as well as a greater number of servers.

Upon receiving the annotated electronic mail message from the sender, the mail server 108 may authenticate the format of the metadata provided in the electronic mail message. Specifically, the format of the metadata may be verified against a standardized metadata format or other protocol. Authentication may use DomainKeys, DomainKeys Identified Mail (DKIM), Sender Policy Framework (SPF), or a similar authentication protocol.

The mail server 108 may send the annotated electronic mail message to the electronic mail box of the recipient. In accordance with various embodiments, the mail server 108 may extract metadata and/or corresponding data from the electronic mail message and store the metadata and/or corresponding data. In other embodiments, another server such as the annotation server 110 may extract and store the metadata and/or corresponding data.

When the recipient (i.e., addressee or user) 112 opens the electronic mail message in his or her mail box, the electronic mail message may be displayed in accordance with at least a portion of the associated metadata. In addition, the electronic mail message may be further processed in accordance with at least a portion of the associated metadata. For instance, the recipient 112 may interact with the electronic mail message via one or more hypertext links provided in the electronic mail message. As another example, information may be automatically obtained at the time that the electronic mail message is opened and provided in the body of the electronic mail message that has been displayed. As yet another example, a clickable button may be added to the electronic mail message, enabling the recipient to click the button to invoke a function such as altering the displayed contents of the message or sending a signal to another web site. Processing of the metadata and/or data may be performed by the mail server 108, annotation server 110, or a client device accessed by the recipient 112 (e.g., via Yahoo Mail or other mail messaging product).

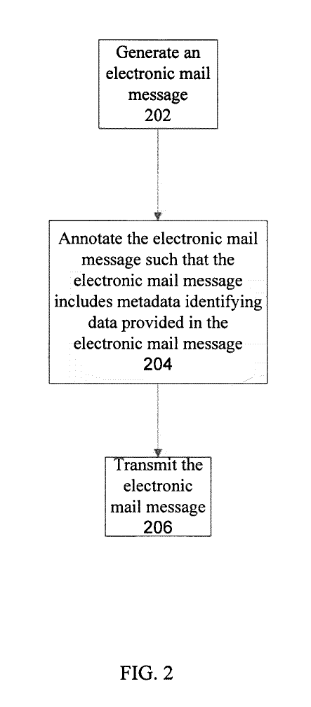

FIG. 2 is a process flow diagram illustrating an example method of annotating an electronic mail message in accordance with one embodiment. An electronic mail message may be generated at 202. The electronic mail message may be composed by a user, or may be generated automatically without initiation by a user. More particularly, the electronic mail message may be generated to include data in a body and/or one or more attachment(s) of the electronic mail message.

The electronic mail message may be annotated at 204 such that the electronic mail message includes metadata identifying data provided in the electronic mail message. For instance, the metadata may identify at least a portion of all data provided in the electronic mail message. The electronic mail message may be annotated automatically. In one embodiment, various data entities may be annotated according to a destination domain of the electronic mail message. Once the electronic mail message has been automatically annotated, a user may confirm that the metadata accurately identifies the data provided in the electronic mail message. In addition, the user may correct any automatically generated metadata that does not correctly identify data provided in the electronic mail message.

Alternatively, rather than automatically annotating the electronic mail message, a user may annotate the electronic mail message via a graphical user interface. More particularly, a graphical user interface configured to receive annotations may be presented. Input (e.g, annotations) may be received via the graphical user interface, enabling the electronic mail message to be annotated using input received via the graphical user interface. The electronic mail message may then be transmitted at 206.

Examples of data entities that may be identified via metadata include numerical values such as phone numbers, flight numbers, and order numbers. Other examples of data entities that may be identified via metadata include textual information such as addresses, product names, and dates. Other data entities that may be identified by metadata include hypertext links.

Annotation of the electronic mail message may be accomplished in various ways. First, a header may be appended to the electronic mail message, where the header includes metadata that identifies one or more entities in the electronic mail message. Second, one or more attachments may be appended to the electronic mail message, where the attachments include metadata identifying one or more entities in the electronic mail message. Third, metadata may be embedded in a body of the electronic mail message, where the metadata identifies one or more entities in the electronic mail message. For instance, one or more tags may be embedded in the body of the electronic mail message. Furthermore, data may be repeated in the pertinent portion of the electronic mail message in order to ensure that the metadata is associated with the corresponding data. An electronic mail message may be annotated using one or more of these methods. Thus, these methods may be combined with one another. For example, one or more tags may be embedded in a body of the electronic mail message in addition to an attachment appended to the electronic mail message.

In addition to identifying various data entities in the electronic mail message, the metadata may further indicate a manner in which the entities in the electronic mail message are to be processed by a receiving device after the electronic mail message has been received. Specifically, the metadata may indicate one or more actions to be taken in association with at least a portion of the data in the electronic mail message.

Annotation of an electronic mail message may be performed using a variety of protocols. In one embodiment, metadata and/or data may be embedded as tags of a Hyper Text Markup Language (HTML) message. In another embodiment, the electronic mail message may be generated and annotated with metadata and/or data using Multipurpose Internet Mail Extensions (MIME). More particularly, the metadata and/or corresponding data may be provided in one or more MIME portions of the electronic mail message. These portions may include a header, one or more portions of a body of the electronic mail message, and/or one or more attachments to the electronic mail message. When data is annotated, the corresponding data may be repeated in the pertinent MIME portion so that the data is correlated with the corresponding metadata. In this manner, structured data may be transmitted in an electronic mail message.

### MIME

Multipurpose Internet Mail Extensions (MIME) is an Internet standard that extends the format of electronic mail (e-mail) to support:
Text in character sets other than ASCII
Non-text attachments
Message bodies with multiple parts
Header information in non-ASCII character sets

Virtually all human-written Internet e-mail and a fairly large proportion of automated e-mail is transmitted via Simple Mail Transfer Protocol (SMTP) in MIME format. MIME is specified in six linked Request for Comments (RFC) memoranda: RFC 2045, RFC 2046, RFC 2047, RFC 4288, RFC 4289, and RFC 2049.

The basic Internet e-mail transmission protocol, SMTP, supports only 7-bit ASCII characters. This effectively limits Internet e-mail to messages which, when transmitted, include only the characters sufficient for writing a small number of languages, primarily English. Other languages based on the Latin alphabet typically include diacritics not supported in 7-bit ASCII, meaning text in these languages cannot be correctly represented in basic e-mail.

MIME defines mechanisms for sending other kinds of information in e-mail. These include text in languages other than English using character encodings other than ASCII, and 8-bit binary content such as files containing images, sounds, movies and/or computer programs. MIME is also a fundamental component of communication protocols such as Hypertext Transfer Protocol (HTTP), which requires that data be transmitted in the context of e-mail-like messages even though the data might not (and usually doesn't) actually have anything to do with e-mail. Mapping messages into and out of MIME format is typically done automatically by an e-mail client or by mail servers when sending or receiving Internet (SMTP/MIME) e-mail.

The basic format of Internet e-mail is defined in RFC 5322, which is an updated version of RFC 2822 and RFC 822. These standards specify the familiar formats for text e-mail headers and body and rules pertaining to commonly used header fields such as “To:”, “Subject:”, “From:”, and “Date:”. MIME defines a collection of e-mail headers for specifying additional attributes of a message including content type, and defines a set of transfer encodings which can be used to represent 8-bit binary data using characters from the 7-bit ASCII character set. MIME also specifies rules for encoding non-ASCII characters in e-mail message headers, such as “Subject:”, allowing these header fields to contain non-English characters.

MIME is extensible. Its definition includes a method to register new content types and other MIME attribute values.

The goals of the MIME definition included requiring no changes to existent e-mail servers and allowing plain text e-mail to function in both directions with existing clients. These goals were achieved by using additional RFC 822-style headers for all MIME message attributes and by making the MIME headers optional with default values ensuring a non-MIME message is interpreted correctly by a MIME-capable client.

### I. MIME Headers

MIME-Version The presence of this header indicates the message is MIME-formatted. The value is typically “1.0” so this header appears as
MIME-Version: 1.0

### Content-ID

The Content-ID header is primarily of use in multi-part messages (as discussed below); a Content-ID is a unique identifier for a message part, allowing it to be referred to (e.g., in IMG tags of an HTML message allowing the inline display of attached images). The content ID is contained within angle brackets in the Content-ID header. Here is an example:
Content-ID: <5.31.32252.1057009685@server01.example.net>

The standards provide that a Content-ID should be globally and permanently unique (meaning that no two are the same, even when generated by different people in different times and places). To achieve this, some conventions have been adopted; one of them is to include an at sign @, with the hostname of the computer which created the content ID to the right of it. This ensures the content ID is different from any created by other computers. Then, the part to the left of the at sign is designed to be unique within that machine; a good way to do this is to append several constantly-changing strings that programs have access to. In this case, four different numbers were inserted, with dots between them: the rightmost one is a timestamp of the number of seconds since Jan. 1, 1970; to the left of it is the process ID of the program that generated the message (on servers running Unix or Linux, each process has a number which is unique among the processes in progress at any moment, though they do repeat over time); to the left of that is a count of the number of messages generated so far by the current process; and the leftmost number is the number of parts in the current message that have been generated so far. Put together, these guarantee that the content ID will never repeat; even if multiple messages are generated within the same second, they either have different process IDs or a different count of messages generated by the same process.

There's a similar header called Message-ID which assigns a unique identifier to the message as a whole; this is not actually part of the MIME standards, since it can be used on non-MIME as well as MIME messages. If the originating mail program doesn't add a message ID, a server handling the message later on probably will.

### Content-Type

This header indicates the Internet media type of the message content, consisting of a type and subtype, for example
Content-Type: text/plain

Through the use of the multipart type, MIME allows messages to have parts arranged in a tree structure where the leaf nodes are any non-multipart content type and the non-leaf nodes are any of a variety of multipart types. This mechanism supports:
simple text messages using text/plain (the default value for “Content-Type:”)
text plus attachments (multipart/mixed with a text/plain part and other non-text parts). A MIME message including an attached file generally indicates the file's original name with the “Content-disposition:” header, so the type of file is indicated both by the MIME content-type and the filename extension
rely with original attached (multipart/mixed with a text/plain part and the original message as a message/rfc822 part)
alternative content, such as a message sent in both plain text and another format such as HTML (multipart/alternative with the same content in text/plain and text/html forms)
image, audio, video and application (for example, image/jpg, audio/mp3, video/mp4, and application/msword and so on)
many other message constructs

### Content-Disposition

The original MIME specifications only provided a means to associate filenames with application/octet-stream parts. This was done through the use of a name=parameter on the content-type. The theory here was that filenames were mostly used for type information and therefore did not need to be present in most cases. The specification of content-disposition attempted to provide a more general means of providing file name information by defining a filename parameter as part of the content-disposition field.

The following example is taken from RFC 2183, where the header is defined
Content-Disposition: attachment; filename=genome.jpeg;
   modification-date=“Wed, 12 Feb 1997 16:29:51-0500”;

The filename may be encoded as defined by RFC 2231. Besides attachment, one can specify inline, or any other disposition type. Unfortunately, no name is defined for the nominal “default” disposition that corresponds to no content-disposition being present. Thus the recommended practice for generating agents is to only include filename information when it is necessary, also to avoid leaking sensitive information. If filename information has to be included, an agent should either put it in a filename=parameter or both a filename=and name=parameter.

### Content-Transfer-Encoding

In June 1992, MIME (RFC 1341, since made obsolete by RFC 2045) defined a set of methods for representing binary data in ASCII text format. The content-transfer-encoding: MIME header has 2-sided significance:
1. It indicates whether or not a binary-to-text encoding scheme has been used on top of the original encoding as specified within the Content-Type header, and
2. If such a binary-to-text encoding method has been used it states which one.

The RFC and the IANA's list of transfer encodings define the values shown below, which are not case sensitive. Note that ‘7bit’, ‘8bit’, and ‘binary’ mean that no binary-to-text encoding on top of the original encoding was used. In these cases, the header is actually redundant for the email client to decode the message body, but it may still be useful as an indicator of what type of object is being sent. Values ‘quoted-printable’ and ‘base64’ tell the email client that a binary-to-text encoding scheme was used and that appropriate initial decoding is necessary before the message can be read with its original encoding (e.g. UTF-8).
Suitable for use with normal SMTP:
   7bit—up to 998 octets per line of the code range 1..127 with CR and LF (codes 13 and 10 respectively) only allowed to appear as part of a CRLF line ending. This is the default value.
   quoted-printable—used to encode arbitrary octet sequences into a form that satisfies the rules of 7bit. Designed to be efficient and mostly human readable when used for text data consisting primarily of US-ASCII characters but also containing a small proportion of bytes with values outside that range.
   base64—used to encode arbitrary octet sequences into a form that satisfies the rules of 7bit. Designed to be efficient for non-text 8bit data. Sometimes used for text data that frequently uses non-US-ASCII characters.
Suitable for use with SMTP servers that support the 8BITMIME SMTP extension:
   8bit—up to 998 octets per line with CR and LF (codes 13 and 10 respectively) only allowed to appear as part of a CRLF line ending.
Suitable only for use with SMTP servers that support the BINARYMIME SMTP extension (RFC 3030):
   binary—any sequence of octets.

There is no encoding defined which is explicitly designed for sending arbitrary binary data through SMTP transports with the 8BITMIME extension. Thus base64 or quoted-printable (with their associated inefficiency) must sometimes still be used. This restriction does not apply to other uses of MIME such as Web Services with MIME attachments.

### II. Encoded-Word

Since RFC 2822, message header names and values are always ASCII characters; values that contain non-ASCII data must use the MIME encoded-word syntax (RFC 2047) instead of a literal string. This syntax uses a string of ASCII characters indicating both the original character encoding (the “charset”) and the content-transfer-encoding used to map the bytes of the charset into ASCII characters.
The form is: “=?charset?encoding?encoded text?=”.
   charset may be any character set registered with IANA. Typically it would be the same charset as the message body.
   encoding can be either “_{Q}” denoting Q-encoding that is similar to the quoted-printable encoding, or “B” denoting base64 encoding.
   encoded text is the Q-encoded or base64-encoded text.

### Difference Between Q-Encoding and Quoted-Printable

The ASCII codes for the question mark (?) and equals sign may not be represented directly as they are used to delimit the encoded-word. The ASCII code for space may not be represented directly because it could cause older parsers to split up the encoded word undesirably. To make the encoding smaller and easier to read the underscore is used to represent the ASCII code for space creating the side effect that underscore cannot be represented directly. Use of encoded words in certain parts of headers imposes further restrictions on which characters may be represented directly.

For example,
Subject: =?iso-8859-1?Q?=AlHola,_se=Flor!?=is interpreted as “Subject: ᵢHola, señor!”.

The encoded-word format is not used for the names of the headers (for example Subject). These header names are always in English in the raw message. When viewing a message with a non-English e-mail client, the header names are usually translated by the client.

### III. Multipart Messages

A MIME multipart message contains a boundary in the “Content-Type:” header; this boundary, which must not occur in any of the parts, is placed between the parts, and at the beginning and end of the body of the message, as follows:

MIME-Version: 1.0
Content-Type: multipart/mixed; boundary=“frontier”
This is a message with multiple parts in MIME format.
--frontier
Content-Type: text/plain
This is the body of the message.
--frontier
Content-Type: application/octet-stream
Content-Transfer-Encoding: base64
PGh0bWw+CiAgPGhlYWQ+CiAgPC9oZWFkPgogIDxib2-
R5PgogICAgPHA+VGhpcyBpcyB0aGUg
Ym9keSBvZiB0aGUgbWVzc2FnZS48L3A+CiAgPC9ib2R5Pg-
o8L2h0bWw+Cg==
--frontier--

Each part consists of its own content header (zero or more Content-header fields) and a body. Multipart content can be nested. The content-transfer-encoding of a multipart type must always be “7bit”, “8bit” or “binary” to avoid the complications that would be posed by multiple levels of decoding. The multipart block as a whole does not have a charset; non-ASCII characters in the part headers are handled by the Encoded-Word system, and the part bodies can have charsets specified if appropriate for their content-type.

### Notes:

Before the first boundary is an area that is ignored by MIME compliant clients. This area is generally used to put a message to users of old non-MIME clients.
It is up to the sending mail client to choose a boundary string that doesn't clash with the body text. Typically this is done by inserting a long random string.
The last boundary must have two hyphens at the end.

### Multipart Subtypes

The MIME standard defines various multipart-message subtypes, which specify the nature of the message parts and their relationship to one another. The subtype is specified in the “Content-Type” header of the overall message. For example, a multipart MIME message using the digest subtype would have its Content-Type set as “multipart/digest”.

The RFC initially defined 4 subtypes: mixed, digest, alternative and parallel. A minimally compliant application must support mixed and digest; other subtypes are optional. Additional subtypes, such as signed and form-data, have since been separately defined in other RFCs.

The following is a list of the most commonly used subtypes; it is not intended to be a comprehensive list.

### Mixed

Multipart/mixed is used for sending files with different “Content-Type” headers inline (or as attachments). If sending pictures or other easily readable files, most mail clients will display them inline (unless otherwise specified with the “Content-disposition” header). Otherwise it will offer them as attachments. The default content-type for each part is “text/plain.”

### Message

A message/rfc822 part contains an email message, including any headers. Rfc822 is a misnomer, since the message may be a full MIME message. This is used for digests as well as for E-mail forwarding.

### Digest

Multipart/digest is a simple way to send multiple text messages. The default content-type for each part is “message/rfc822”.

### Alternative

The multipart/alternative subtype indicates that each part is an “alternative” version of the same (or similar) content, each in a different format denoted by its “Content-Type” header. The formats are ordered by how faithful they are to the original, with the least faithful first and the most faithful last. Systems can then choose the “best” representation they are capable of processing; in general, this will be the last part that the system can understand, although other factors may affect this.

Since a client is unlikely to want to send a version that is less faithful than the plain text version this structure places the plain text version (if present) first. This makes life easier for users of clients that do not understand multipart messages.

Most commonly multipart/alternative is used for email with two parts, one plain text (text/plain) and one HTML (text/html). The plain text part provides backwards compatibility while the HTML part allows use of formatting and hyperlinks. Most email clients offer a user option to prefer plain text over HTML; this is an example of how local factors may affect how an application chooses which “best” part of the message to display.

While it is intended that each part of the message represent the same content, the standard does not require this to be enforced in any way.

### Related

A multipart/related is used to indicate that message parts should not be considered individually but rather as parts of an aggregate whole. The message consists of a root part (by default, the first) which reference other parts inline, which may in turn reference other parts. Message parts are commonly referenced by the “Content-ID” part header. The syntax of a reference is unspecified and is instead dictated by the encoding or protocol used in the part.

One common usage of this subtype is to send a web page complete with images in a single message. The root part would contain the HTML document, and use image tags to reference images stored in the latter parts.

### Report

Multipart/report is a message type that contains data formatted for a mail server to read. It is split between a text/plain (or some other content/type easily readable) and a message/delivery-status, which contains the data formatted for the mail server to read.

### Signed

A multipart/signed message is used to attach a digital signature to a message.

It has two parts, a body part and a signature part. The whole of the body part, including mime headers, is used to create the signature part. Many signature types are possible, like application/pgp-signature (RFC 3156) and application/x-pkcs7-signature (S/MIME).

### Encrypted

A multipart/encrypted message has two parts. The first part has control information that is needed to decrypt the application/octet-stream second part. Similar to signed messages, there are different implementations which are identified by their separate content types for the control part. The most common types are “application/pgp-encrypted” (RFC 3156) and “application/pkcs7-mime” (S/MIME).

### Form Data

As its name implies, multipart/form-data is used to express values submitted through a form. Originally defined as part of HTML 4.0, it is most commonly used for submitting files via HTTP.

### Mixed-Replace (Experimental)

The content type multipart/x-mixed-replace was developed as part of a technology to emulate server push and streaming over HTTP.

All parts of a mixed-replace message have the same semantic meaning. However, each part invalidates—“replaces”—the previous parts as soon as it is received completely. Clients should process the individual parts as soon as they arrive and should not wait for the whole message to finish.

It is commonly used in IP cameras as the MIME type for MJPEG streams.

### Byteranges

The multipart/byteranges is used to represent noncontiguous byte ranges of a single message. It is used by HTTP when a server returns multiple byte ranges and is defined in RFC 2068.

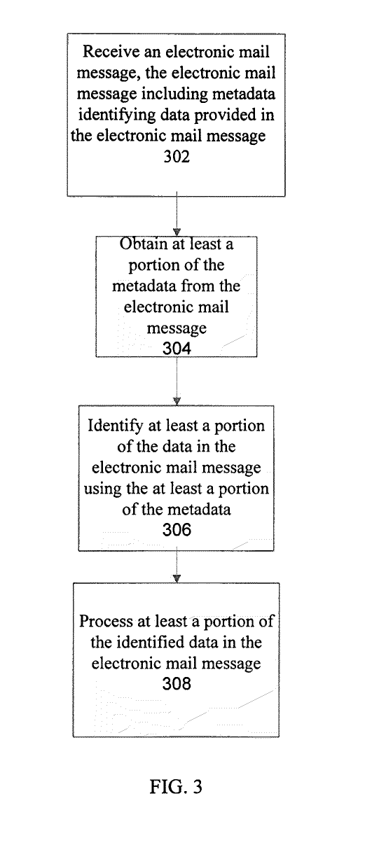

FIG. 3 is a process flow diagram illustrating an example method of processing an annotated electronic mail message in accordance with one embodiment. An electronic mail message may be received at 302, where the electronic mail message includes metadata identifying data provided in the electronic mail message. At least a portion of the metadata may be obtained from the electronic mail message at 304. As set forth above, the metadata may be provided in a header of the electronic mail message, one or more attachments to the electronic mail message, and/or one or more portions of a body of the electronic mail message. At least a portion of the data in the electronic mail message may be identified using at least a portion of the metadata at 306. More particularly, the metadata may identify one or more entities in the electronic mail message (e.g., in the body and/or attachment(s)). At least a portion of the identified data in the electronic mail message may then be processed at 308. The electronic mail message may then be provided (e.g., displayed) using the metadata. The various processes of processing an annotated electronic mail message may be performed by a product such as Yahoo Mail.

In one embodiment, the metadata further indicates one or more actions to be taken in association with at least a portion of the data in the electronic mail message by a receiving device after the electronic mail message has been received by the receiving device. In another embodiment, computer-readable instructions may be configured to perform a corresponding set of one or more actions in association with at least a portion of the data.

Various actions may be performed in association with the data in the electronic mail message (or portion thereof). These actions may include storing, processing, and/or displaying the data in a particular manner. As one example, a tag may identify a particular airline flight number. Information associated with the data (e.g., flight number) identified by the tag may be obtained and displayed. Furthermore, the information may be obtained in response to user input such as clicking on a link provided in the electronic mail message. The information may be obtained from a source external to the electronic mail message program, such as via an external web site. The information may then be displayed within a graphical user interface provided within the electronic mail messaging program.

Displaying of tagged data or information associated with tagged data may be performed within a graphical user interface without leaving the context of the electronic mail messaging program. For instance, where information associated with a particular flight is obtained and displayed, these processes may be performed without requiring the user to open a new browser window to access another web site.

Metadata may also indicate various actions to be performed in association with the data in the electronic mail message (or portion thereof). For instance, metadata may indicate display features such as bold, underline, font type, font size, etc. Thus, the electronic mail message may be displayed using the metadata. Metadata may also indicate further actions to be performed, such as a manner in which data is to be processed or stored, user input that is to be obtained, etc.

All electronic mail messages that have been received may be stored for later retrieval. Since one or more entities of data in an electronic mail message may be tagged, the electronic mail messages may be queried based upon the tagged entities. For instance, a user may wish to query the stored electronic mail messages to identify those electronic mail messages including a hypertext link. In this example, electronic mail messages may be identified by searching the electronic mail messages for a tag that identifies a hypertext link. Thus, a subset of the stored electronic mail messages may be identified based upon the presence of a tag and/or a particular value of a tag

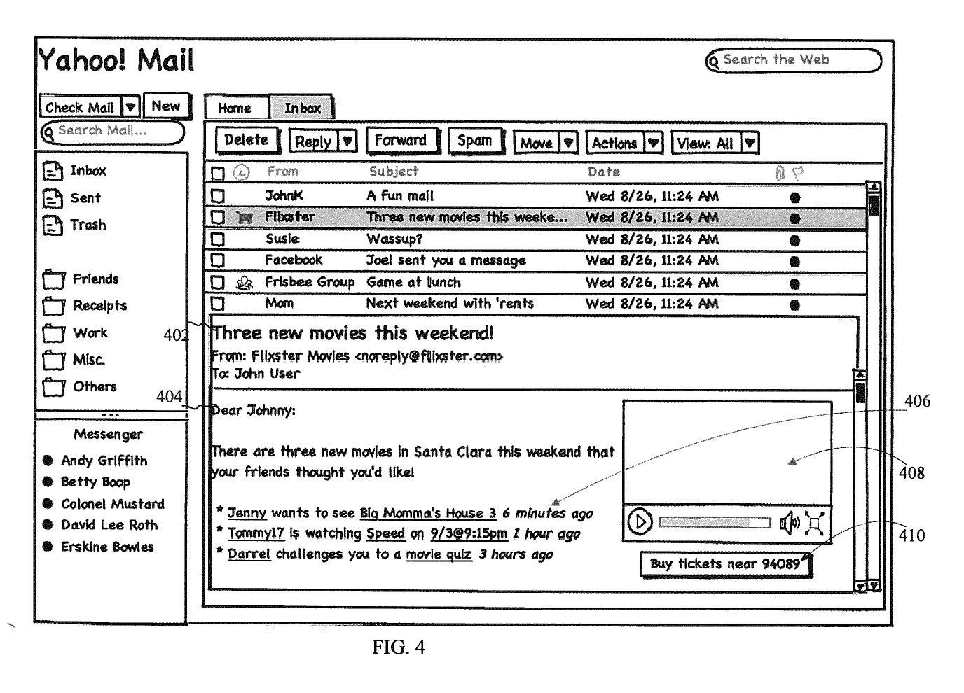

FIGS. 4-6 are diagrams illustrating example graphical user interfaces presenting example annotated electronic mail messages in accordance with various embodiments. More particularly, each of the screen shots illustrates the electronic mail message recipient's Inbox and an annotated electronic mail message that has been opened by the recipient. Each electronic mail message may be displayed in accordance with the corresponding metadata. More particularly, a client implementing a product such as Yahoo Mail can provide a User Interface for the recipient within the context of the electronic mail message interface (e.g., window). This enables the recipient to complete a task interactively without opening a new browser window.

FIG. 4 illustrates an example electronic mail message that includes a header 402 and a body 404. The header 402 identifies the sender and the recipient of the electronic mail message. In this example, the sender is Flixster Movies and the recipient is John User.

As shown in FIG. 4, the body 404 of the electronic mail message may include real-time updates 406. For example, the real-time updates may be obtained from a website such as Flixster Movies. In this example, the recipient is presented with movie recommendations from three of his friends. Each of the movie recommendations identifies a friend, the friend's movie recommendation, and the time that the movie recommendation was provided by the friend.

In order to display the movie recommendations, the sender of the electronic mail message may provide metadata in the electronic mail message that identifies each of the friends, indicates that the most recent movie recommendation provided by each of the friends is to be obtained from the Flixster website and presented in the body 404 along with the time that the movie recommendation was last updated by the friend via the website. The metadata may also indicate the desired presentation of the movie recommendations. (In this example, the name of the friend and the name of the movie are underlined, while the time that the movie recommendation was provided by the friend may be presented in italics.)

The body 404 may also include a video player as shown at 408, which presents a movie preview or advertisement within the body 404 of the electronic mail message. The movie preview or advertisement may be obtained from the website.

In addition, the recipient of the electronic mail message may obtain information or perform a particular task interactively. In this example, the metadata may identify a hypertext link, represented by box 410, via which the recipient may purchase movie tickets (e.g., near their location). The metadata may indicate that the recipient's zip code is to be obtained automatically and provided in the box 410. The recipient may then click on the box 410 and purchase tickets for a movie. The recipient may be returned to the electronic mail message after the recipient has purchased movie tickets. Thus, the recipient need not exit the electronic mail messaging program in order to obtain interactive content or open a new browser window to access the desired website.

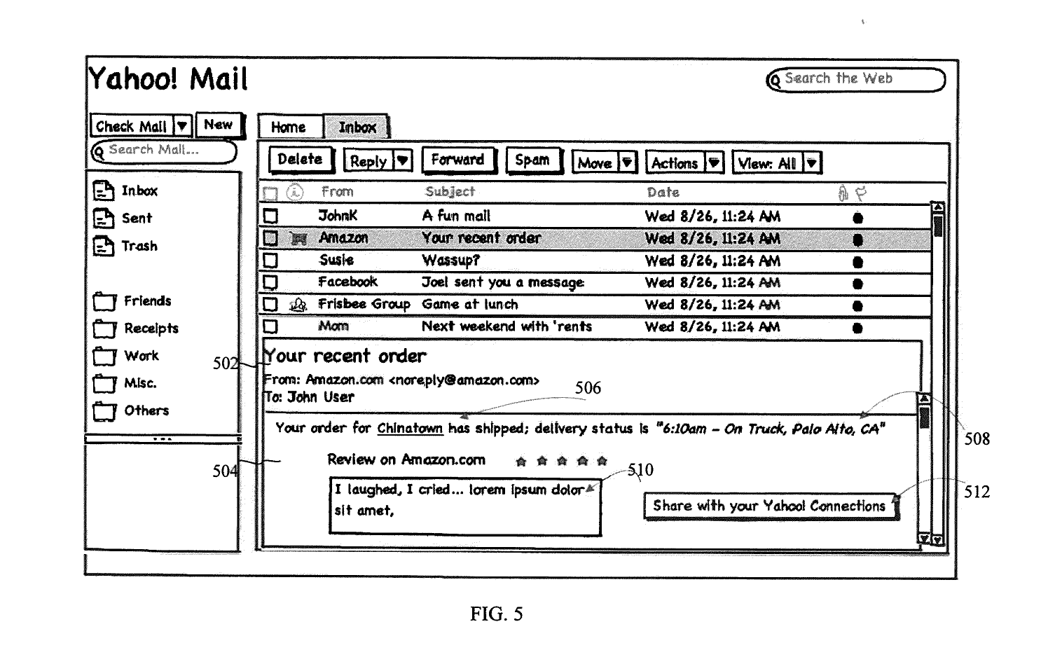

FIG. 5 illustrates another example electronic mail message. Header 502 identifies the sender and the recipient of the electronic mail message. In this example, the sender is Amazon.com and the recipient is John User.

As shown in FIG. 5, body 504 of the electronic mail message may identify a product 506 that has been ordered from the sender and shipped. A delivery status or UPS tracking number may also be provided at 508.

The metadata of the electronic mail message may enable the recipient to create or edit a review of the product 506 via the sender's website as shown at 510. For example, when the recipient creates a review via input box 510, the metadata may indicate that the reviews present on the sender's website for the product 506 are to be automatically updated with the recipient's review. More particularly, the metadata may provide instructions to access the sender's website or a particular application via a particular hypertext link. The recipient may then choose to share their review with his connections (e.g., Yahoo! Connections) as shown at 512. For instance, the metadata of the electronic mail message may indicate that when the user clicks on box 512 (e.g., hypertext link), the recipient's review of the product is to be automatically transmitted to the recipient's connections.

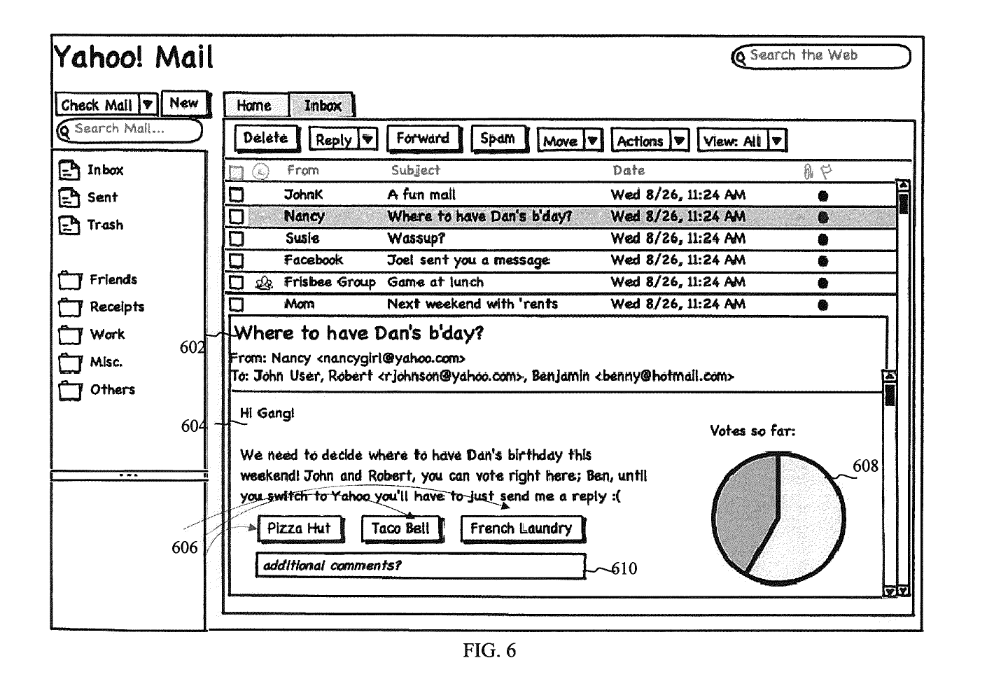

FIG. 6 illustrates another example electronic mail message. Header 602 identifies the sender and recipient(s) of the electronic mail message. The metadata of the electronic mail message may instruct the receiving device of the electronic mail message to display specified options in body 604 of the electronic mail message to enable the recipients of the electronic mail message to submit a vote at 606. In addition, the metadata of the electronic mail message may also indicate that real-time updates with respect to the votes are to be obtained so that the recipients' votes may be presented to the recipients at 608.

In this example, the recipients may vote on a location to have a birthday party, where the options are shown at 606. More particularly, the recipients may choose Pizza Hut, Taco Bell, or French Laundry. The voting options may be presented as hypertext links. In accordance with various embodiments, clicking the links does not open a new web browser. Rather, upon clicking on one of the hypertext links, the voting distribution shown at 608 may be updated immediately. The metadata may also provide an input portion of the body 604 so that recipients may provide additional comments regarding their selection at 610. This information may then be stored, as appropriate.

The resulting distribution of the recipients' votes may be presented at 608. These comments may be automatically distributed to the recipients in accordance with the metadata. In this example, a pie chart is presented at 608 within the body 604 of the electronic mail message.

It is important to note that the examples described herein are merely illustrative. Therefore, metadata may be used to achieve a variety of results. For instance, metadata may be used to control the content that is displayed within the body of an electronic mail message. For instance, the metadata provided in the electronic mail message may designate that “if (today's date <Jan-24-2010) then show paragraph 1, else show paragraph 2.” Thus, in this example, content of an electronic mail message such as an advertisement may vary based upon the date that the user opens the electronic mail message.

The disclosed embodiments provide a user with a more sophisticated user experience. Users may complete a wide variety of tasks from within the electronic messaging interface without opening a new browser window. In many instances, this may be accomplished from within the body of the electronic mail message. Accordingly, the disclosed embodiments provide numerous advantages over the prior art.

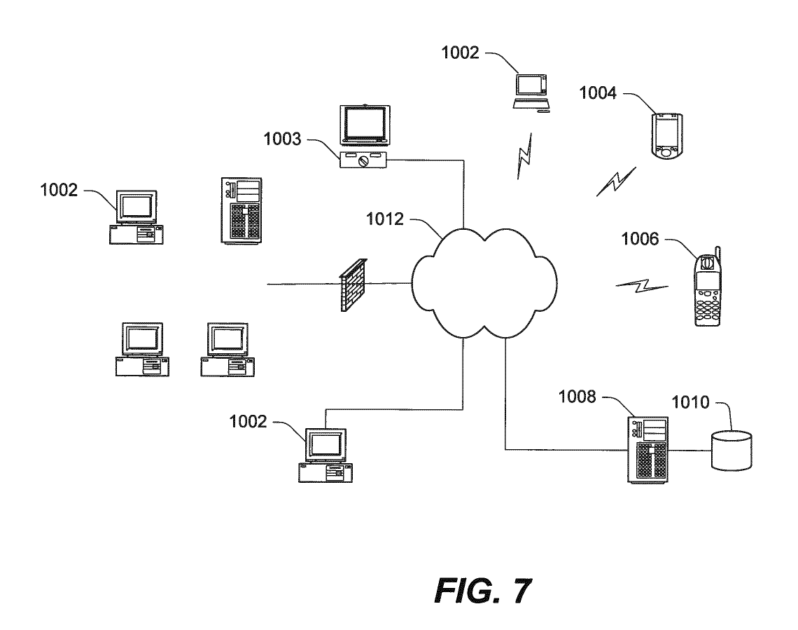

Embodiments of the present invention may be employed to generate or process an annotated electronic mail message in any of a wide variety of computing contexts. For example, as illustrated in FIG. 7, implementations are contemplated in which the relevant population of users interact with a diverse network environment via any type of computer (e.g., desktop, laptop, tablet, etc.) 1002, media computing platforms 1003 (e.g., cable and satellite set top boxes and digital video recorders), handheld computing devices (e.g., PDAs) 1004, cell phones 1006, or any other type of computing or communication platform.

An electronic mail message may be generated or processed according to the invention in some centralized manner. This is represented in FIG. 7 by server 1008 and data store 1010 which, as will be understood, may correspond to multiple distributed devices and data stores. The invention may also be practiced in a wide variety of network environments (represented by network 1012) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques of the present invention may be implemented in any suitable combination of software and/or hardware system, such as a web-based server or desktop computer system. The annotated message processing apparatus of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store annotated electronic mail messages, metadata obtained from the electronic mail messages and/or data obtained from the electronic mail messages, computer-readable instructions for annotating electronic mail messages, computer-readable instructions for generating a graphical user interface enabling a user to annotate an electronic mail messages, computer-readable instructions for processing annotated electronic mail messages, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

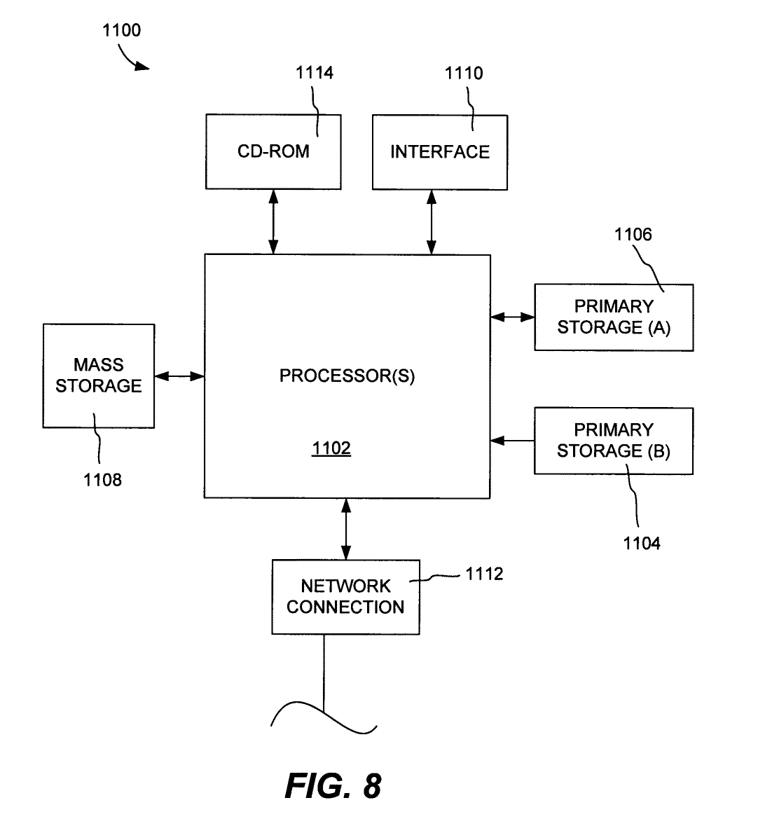

FIG. 8 illustrates a typical computer system that, when appropriately configured or designed, can serve as a system of this invention. The computer system 1100 includes any number of processors 1102 (also referred to as central processing units, or CPUs) that are coupled to storage devices including primary storage 1106 (typically a random access memory, or RAM), primary storage 1104 (typically a read only memory, or ROM). CPU 1102 may be of various types including microcontrollers and microprocessors such as programmable devices (e.g., CPLDs and FPGAs) and unprogrammable devices such as gate array ASICs or general purpose microprocessors. As is well known in the art, primary storage 1104 acts to transfer data and instructions uni-directionally to the CPU and primary storage 1106 is used typically to transfer data and instructions in a bi-directional manner. Both of these primary storage devices may include any suitable computer-readable media such as those described above. A mass storage device 1108 is also coupled bi-directionally to CPU 1102 and provides additional data storage capacity and may include any of the computer-readable media described above. Mass storage device 1108 may be used to store programs, data and the like and is typically a secondary storage medium such as a hard disk. It will be appreciated that the information retained within the mass storage device 1108, may, in appropriate cases, be incorporated in standard fashion as part of primary storage 1106 as virtual memory. A specific mass storage device such as a CD-ROM 1114 may also pass data uni-directionally to the CPU.

CPU 1102 may also be coupled to an interface 1110 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1102 optionally may be coupled to an external device such as a database or a computer or telecommunications network using an external connection as shown generally at 1112. With such a connection, it is contemplated that the CPU might receive information from the network, or might output information to the network in the course of performing the method steps described herein.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
generating an electronic mail message;
annotating the electronic mail message such that the electronic mail message includes metadata identifying data provided in the electronic mail message; and
transmitting the electronic mail message.

2. The method as recited in claim 1, wherein annotating the electronic mail message comprises:
appending a header to the electronic mail message, wherein the header includes metadata that identifies one or more entities in the electronic mail message.

3. The method as recited in claim 2, wherein the metadata further indicates a manner in which the entities in the electronic mail message are to be processed by a receiving device after the electronic mail message has been received.

4. The method as recited in claim 1, wherein annotating the electronic mail message comprises:
embedding one or more tags in a body of the electronic mail message that identify one or more entities in the electronic mail message.

5. The method as recited in claim 1, wherein annotating the electronic mail message comprises:
appending one or more attachments to the electronic mail message, wherein the attachments include metadata identifying one or more entities in the electronic mail message.

6. The method as recited in claim 5, wherein the metadata further indicates a manner of processing the entities in the electronic mail message by a receiving device.

7. The method as recited in claim 1, wherein the metadata further indicates one or more actions to be taken in association with at least a portion of the data in the electronic mail message by a receiving device after the electronic mail message has been received by the receiving device.

8. The method as recited in claim 1, wherein annotating is performed automatically.

9. The method as recited in claim 8, further comprising:
obtaining confirmation that the metadata accurately identifies the data provided in the electronic mail message.

10. The method as recited in claim 8, wherein annotating is performed according to a destination domain of the electronic mail message.

11. The method as recited in claim 1, further comprising:
providing a graphical user interface;
wherein annotating the electronic mail message is performed using input received via the graphical user interface.

12. The method as recited in claim 1, wherein the data is provided in at least one of a body or attachment of the electronic mail message.

13. The method as recited in claim 1, wherein annotating the electronic mail message comprises:
generating one or more MIME portions of the electronic mail message, wherein the one or more MIME portions include the metadata.

14. A method, comprising:
receiving an electronic mail message, the electronic mail message including metadata identifying data provided in the electronic mail message;
obtaining at least a portion of the metadata from the electronic mail message;
identifying at least a portion of the data in the electronic mail message using the at least a portion of the metadata; and
processing the at least a portion of the identified data in the electronic mail message.

15. The method as recited in claim 14, wherein the electronic mail message comprises a header, wherein the header includes the metadata, the metadata identifying one or more entities in the electronic mail message.

16. The method as recited in claim 14, wherein the electronic mail message comprises a body, the body including one or more tags that identify one or more entities in the electronic mail message.

17. The method as recited in claim 14, wherein electronic mail message includes one or more attachments, wherein the attachments include metadata identifying one or more entities in the electronic mail message.

18. The method as recited in claim 14, wherein the data is provided in at least one of a body or attachment of the electronic mail message.

19. The method as recited in claim 14, wherein the electronic mail message includes one or more MIME portions, wherein the one or more MIME portions include the metadata.

20. The method as recited in claim 14, wherein the metadata further indicates one or more actions to be taken in association with at least a portion of the data in the electronic mail message by a receiving device after the electronic mail message has been received by the receiving device.

21. The method as recited in claim 20, wherein processing at least a portion of the identified data comprises performing the one or more actions in association with the at least a portion of the data.

22. The method as recited in claim 14, wherein processing at least a portion of the identified data comprises:
obtaining information associated with the identified data; and
displaying the obtained information.

23. The method as recited in claim 22, wherein the information is obtained via a web site.

24. The method as recited in claim 23, wherein the information is obtained in response to input from a user.

25. The method as recited in claim 14, wherein processing at least a portion of the identified data comprises:
displaying information associated with the identified data in accordance with at least a portion of the metadata.

26. An apparatus, comprising:
a processor; and
a memory, at least one of the processor or the memory being adapted for:
receiving an electronic mail message, the electronic mail message including metadata identifying data provided in the electronic mail message;
obtaining at least a portion of the metadata from the electronic mail message;
identifying at least a portion of the data in the electronic mail message using the at least a portion of the metadata; and
processing the at least a portion of the identified data in the electronic mail message.
